(19) United States
(12) Patent Application Publication
(10) Pub. No.: US 2022/0148450 A1
(43) Pub. Date: May 12, 2022

(54) Systems and Methods for Training Persons in the Aiming of Firearms at Moving Targets

(71) Applicant: Marathon Robotics Pty Ltd, Marrickville (AU)

(72) Inventors: Alex Brooks, Marrickville (AU); Alexei Makarenko, Marrickville (AU); Alex Dlugosch, Marrickville (AU); Christopher Lee-Johnson, Marrickville (AU)

(21) Appl. No.: 17/431,047

(22) PCT Filed: Feb. 21, 2020
(86) PCT No.: PCT/AU2020/050149

§ 371 Date: Aug. 13, 2021

(30) Foreign Application Priority Data
Feb. 22, 2019 (AU) 2019900563

(51) Int. Cl. G09B 9/00; F41G 1/473; F41J 9/02; F41G 3/26

(52) U.S. Cl. CPC G09B 9/006; F41G 1/473; F41G 3/2644; F41J 9/02; G09B 9/003

(57) ABSTRACT

A method and system for training a person in the aiming of firearms at moving targets is described, the method including the steps of: providing at least one moving target; calculating the correct lead for the at least one target; displaying a visualisation of the correct lead to the person

### TECHNICAL FIELD

The present invention relates to the field of training persons to aim firearms at moving targets.

### BACKGROUND TO THE INVENTION

The ability to hit a moving target is an important skill for many types of shooters (e.g. military, law-enforcement, hunters). Hitting a static target at a distance requires a shooter to aim above the target; he/she has to aim high because the bullet is affected by gravity throughout its trajectory. A more distant target requires a higher point of aim.

Scopes often have reticle patterns (markings inside the scope) which help a shooter to judge the amount by which they should aim high. Referring to FIG. 1, an example of a scope 10 and reticle 12 are shown. Reticle 12 includes a chevron 14 and below the chevron 14 is a Bullet Drop Compensator (BDC) 16. At short ranges, a shooter places the tip of the chevron 14 on the desired point of impact. The correct point of aim at 400 m is indicated by the tick-mark to the left of the ‘4’, and so on for each marking out to 800 m at the bottom tick-mark.

In addition, and referring to FIG. 2, hitting a moving target requires the shooter to “lead” it. The shooter has to aim in front of the target because the bullet has a non-zero flight-time. As the bullet flies through the air, the target is also moving; only by aiming in front can the shooter arrange for the paths of the bullet and the target to intersect. A shooter needs to know by how much to lead the target, i.e. how far to aim to one side of the target in order to hit it. The required lead depends on various factors including:
1. the speed and acceleration of the target,
2. the direction of the target's motion relative to the line of sight from the shooter (a target charging directly at the shooter requires no lead, a target moving obliquely requires less lead than a target moving left-to-right at 90 degrees, etc)
3. the distance from the shooter to the target
4. the velocity profile of the bullet (depends primarily on the weapon and ammunition, and to a lesser extent on temperature, altitude, and elevation difference between shooter and target).

The required lead can be expressed as a distance (e.g. metres) or an angle (degrees or more commonly Minutes Of Angle (MOA)).

To teach shooters the art of hitting a moving target it has been tried to ask trainee shooters to memorise a table of leads (see FIG. 3) to apply to targets of various speeds and distances. The trainees may then practice shooting moving targets on a range. The targets generally move on rails, or involve a soldier walking behind a protective berm while carrying a stick with a target that protrudes above the berm.

Trainee shooters generally practice shooting very few specific distance/speed/direction combinations: e.g. they may only practice against a target at 100 m moving at 1 m/s, left-to-right at 90 deg to the shooter. As a result, trainee shooters generally memorise the required leads for the specific speed/distance/direction combinations that they practice, and fail to memorise the table.

Even if they could memorise the entire table, there is a big difference between knowing the table and being able to recall it and apply it in the heat of the moment.

One needs to:
1. recall the table,
2. interpolate between cells in the table (e.g. a target at 150 m needs a lead half-way between the 100 m lead and the 200 m lead), and
3. compensate for target direction (e.g. a target moving at a 45 deg angle needs only 70% as much lead).

There remains a need to provide improved methods of training to trainee shooters,

### SUMMARY OF THE INVENTION

In a first aspect the present invention provides a method of training a person in the aiming of firearms at moving targets including the steps of: providing at least one moving target; calculating the correct lead for the at least one target; displaying a visualisation of the correct lead to the person.

The steps of calculating and displaying may be carried out repeatedly to provide an ongoing near real-time visualisation of the correct lead.

The step of calculating the correct lead may be based on any of the location of the target, the velocity of the target, the acceleration of the target or the direction of travel of the target.

The location of the target may include the elevation of the target.

Information relating to the location of the target, the velocity of the target or the direction of travel of the target may be derived from the target.

Information relating to the location of the target, the velocity of the target or the direction of travel of the target may be derived from a target control system.

The step of calculating the correct lead may be based on the location of the person.

The location of the person may include the elevation of the person.

The location of the person may be determined from a sensor such as a GPS sensor placed on or near the person.

The location of the person may be obtained from a previously configured control system.

The calculation of the correct lead may be based on wind speed.

The visualisation may include a representation of the target.

The representation of the target may include a visual indication of the direction of travel of the target relative to the person's line of sight.

the representation of the target includes a visual indication of the distance to the target.

The distance to the target may be indicated by the height of the representation of the target.

The visualisation may include a visual indication of the velocity of the target.

The visual indication of the velocity of the target may include a moving background image which moves to indicate the component of the velocity of the target in a direction orthogonal to the direction from the person to the target.

The visual indication of the velocity of the target may include visual cues in the form of arm or leg movements or leaning of the representation of the target.

The method may further include the step of providing an indication to the person of the accuracy of at least one shot which they fired.

The indication may include an indication of whether the shot was leading or lagging the target.

The indication may include an indication of by how much the shot was leading or lagging the target.

The indication of the accuracy shot may be calculated based on the output of acoustic sensors.

The visual indication may be displayed by overlaying it in a weapon-sight.

In a second aspect, the present invention provides a system for training persons in the aiming of firearms including: at least one target which is arranged to move about an area; calculation means for calculating the correct lead for the at least one target; display means for displaying a visualisation of the correct lead.

The system may be arranged to repeatedly carry out the steps of calculating and displaying to provide an ongoing near real-time visualisation of the correct lead.

The system may be arranged to calculate the correct lead based on any of the location of the target, the velocity of the target, the acceleration of the target or the direction of travel of the target.

The location of the target may include the elevation of the target.

Information relating to the location of the target, the velocity of the target, the acceleration of the target or the direction of travel of the target may be derived from the target.

Information relating to the location of the target, the velocity of the target, the acceleration of the target or the direction of travel of the target may be derived from a target control system.

The system may be arranged to calculate the correct lead based on the location of the person.

The location of the person may include the elevation of the person.

The calculation of the correct lead may be based on wind speed.

The visualisation may include a representation of the target.

The representation of the target may include a visual indication of the direction of travel of the target relative to the person's line of sight.

The representation of the target may include a visual indication of the distance to the target.

The distance to the target may be indicated by the height of the representation of the target.

The visualisation may include a visual indication of the velocity of the target.

The visual indication of the velocity of the target may include a moving background image which moves to indicate the component of the velocity of the target in a direction orthogonal to the direction from the person to the target.

The visual indication of the velocity of the target may include visual cues in the form of arm or leg movements or leaning of the representation of the target.

The system may be further arranged to provide an indication to the person of the accuracy of at least one shot which they fired.

the indication includes an indication of whether the shot was leading or lagging the target.

The indication may include an indication of by how much the shot was leading or lagging the target.

The target may include acoustic sensors and the indication of the accuracy shot is calculated based on the output of the acoustic sensors.

The visual indication may be displayed by overlaying it in a weapon-sight.

### BRIEF DESCRIPTION OF THE DRAWINGS

Embodiments of the present invention will now be described, by way of example only, with reference to the accompanying drawings, in which:

FIG. 1 shows a prior art scope along with the reticle pattern seen when viewing a target through scope 10;

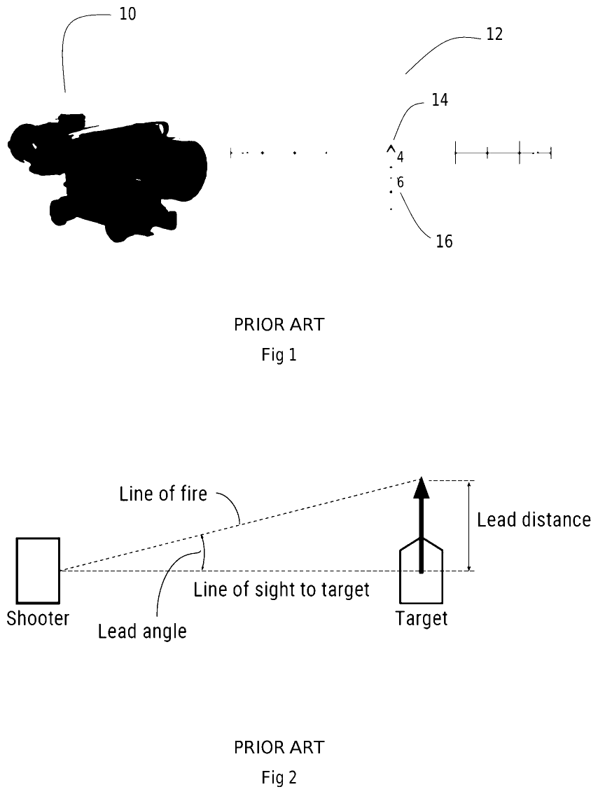

FIG. 2 is an overhead view of a shooter aiming at a target with “lead” applied;

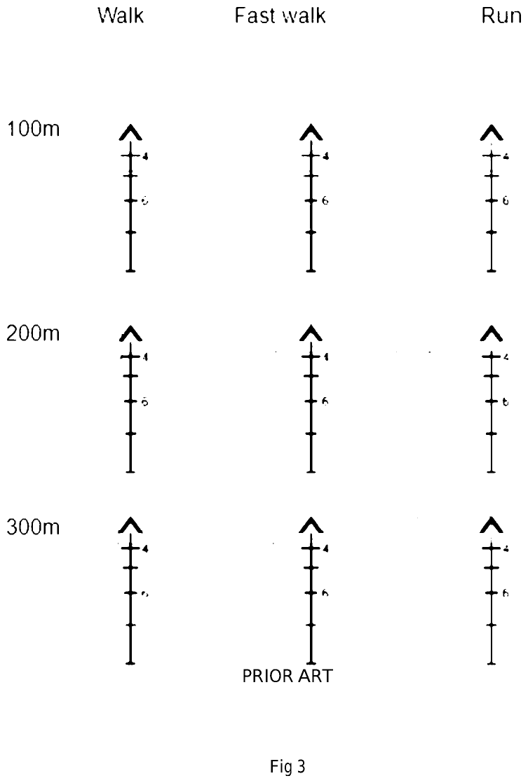

FIG. 3 shows a prior art lead table;

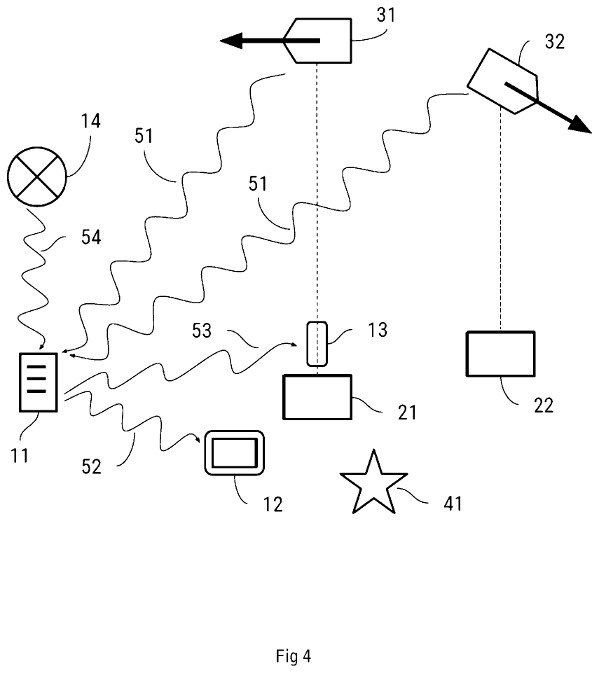

FIG. 4 is a schematic view of the participants in the system;

FIG. 5 shows the display outputted by the system alongside an overhead view of a target and trainee on a firing range;

FIG. 5a shows a display similar to FIG. 5, but with the target approaching the shooter at an oblique angle;

FIG. 5b shows a display similar to FIG. 5, but with the target twice the distance away;

FIG. 6 illustrates an embodiment of invention which provides feedback relating to missed shots;

FIGS. 7a and 7b illustrate the technique of overlaying aim hints onto a weapon sight used by a trainee shooter.

### DETAILED DESCRIPTION OF THE PREFERRED EMBODIMENT

Embodiments of systems and methods according to the invention will now be described. The embodiments are based on modified versions of robotic target systems produced by the applicant and as described, for instance, in applicant's published patent publications WO2011/035363, WO2016/134413 & WO2017/083906, which are incorporated herein by reference.

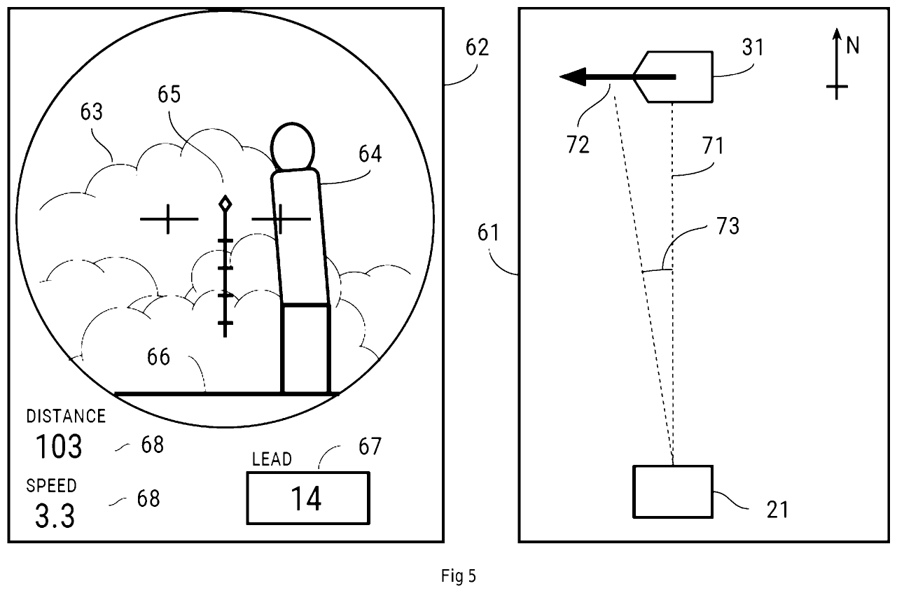

Referring to FIG. 4, a system for training persons in the aiming of firearms is shown including: two targets 31, 32 which are arranged to move about a training area such as a firing range; two shooters 21, 22 who are aiming live-fire weapons at respective targets 31, 32; a target control system 11 which includes calculation means for calculating the correct lead for each shooter and target combination 21, 31 and 22, 32; display means 12 for displaying a visualisation of the correct lead. Also shown is a firearms instructor 41 who is conducting the training session. Also shown are information streams 51 representing communication between the targets 31, 32 and the control system 11; and information stream 52 from the control system 11 to screen 12. The screen may be located where it is viewable by either or both of the instructor 41 and the shooters 21, 22. Weather station 14 is used to gather data to enable the system to compensate for current local atmospheric conditions.

The targets 31, 32 operate under the command of the control system 11 to move about the training area. The trainees must attempt to hit the targets. The training system helps the trainees learn by calculating and displaying the correct lead. There are two approaches to determine the relative position and velocity between the shooter and the target needed for calculating the correct lead.

The first approach relies on knowing the absolute position and velocity of both the target and the shooter and calculating the relative values. The speed and direction of travel of the targets are known by the control system 11 at all times. The location of each shooter 21, 22 is determined by the control system either by placing a sensor such as a GPS sensor on or near the shooters, or by configuring shooter locations in the software of control system 11. Once configured, the configured shooter locations may be updated as needed.

The second approach relies on estimating the relative position and velocity between the shooter and the target directly. The distance to the target could be measured with a laser range finder, or estimated using a camera if the dimensions of the target are known, or configured statically in software. The speed of the target and its direction of motion can be estimated by using computer vision techniques. This approach requires to detect the target object in the camera frame, separate the object from the background, and estimate the object's orientation and motion in 3D space. Some targeting systems today attempt to perform these functions in an operational environment. Performing all these steps on a battlefield is very challenging due to extremely diverse and a priori unknown appearance of the target and the environment. The complexity is reduced in the context of training. The tasks of target detection, tracking, and range and pose estimation are simplified because the target appearance is known. Machine learning can be applied effectively if a large dataset of target images is collected. Further simplifications can be achieved by placing distinctive markers (fiducials) on the moving targets.

Combinations of both approaches are possible. For example the speed and direction of motion of the targets could be supplied by the target system while the distance from the shooter to the target is measured by a laser range finder at the firing line.

Control system 11 determines factors affecting the shooters' bullet velocity-profile. The control system can be configured with the weapon and ammunition type being used by the shooters. The control system may measure or be configured with the current temperature, altitude, and elevation differences between shooters 21, 22 and targets 31, 32. The correct lead is calculated by the control system 11. The lead is then displayed on display screen 12, and updated in real time.

### Calculation of Lead

Bullets decelerate as they fly through the air. Bullet velocity profiles for a specific combination of bullet, cartridge, and weapon are well known or can be obtained experimentally. Further refinements are possible to account for the effect of specific atmospheric conditions.

The distance between the shooter 21 and the target 31 is known due to continuous localisation of the target. The time it takes the decelerating bullet to cover that distance can be looked up from the velocity profile table. The average bullet speed can then be calculated by dividing the shooter-to-target distance by the bullet flight time.

The goal is to find the angle between the line of sight to the target and the line of fire which assures the bullet intercepting the moving target. This angle is known as the “lead angle”. The geometry is defined by a triangle which is formed by a) the current distance between the shooter and the target, b) the distance covered by the bullet to the intercept point, and c) the distance covered by the target to the intercept point. The law of cosines describes a relationship between the length of the triangle sides and the heading angle of the target relative to the shooter. The equation can be solved for the time to intercept. The time to intercept allows to calculate the intercept coordinates and the lead angle.

### Display Options

The system has information about all targets and the graphical user interface can be configured to operate in any of several modes as follows:
the instructor can select a specific target (31 or 32) in the GUI and show aim coaching information just for it.
if the screen is large enough, lead information can be shown for all targets simultaneously
if the range has several firing lanes with a shooter and a target assigned to each lane, then a lane can have a small screen showing aim coaching info for only its own target.

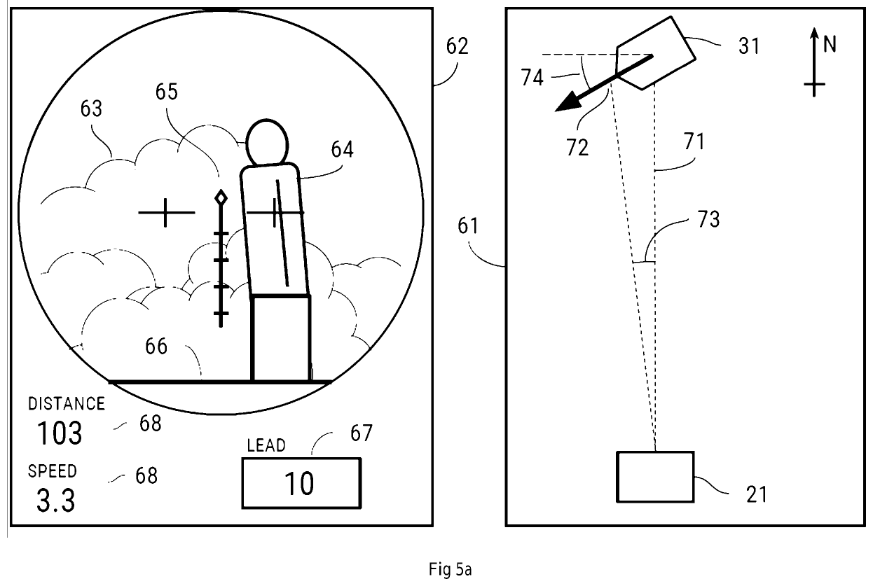

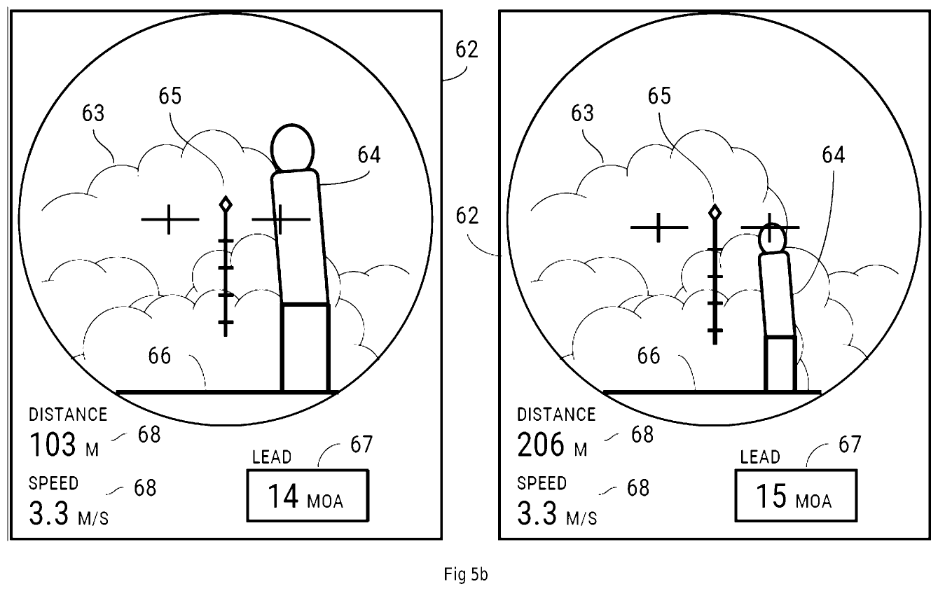

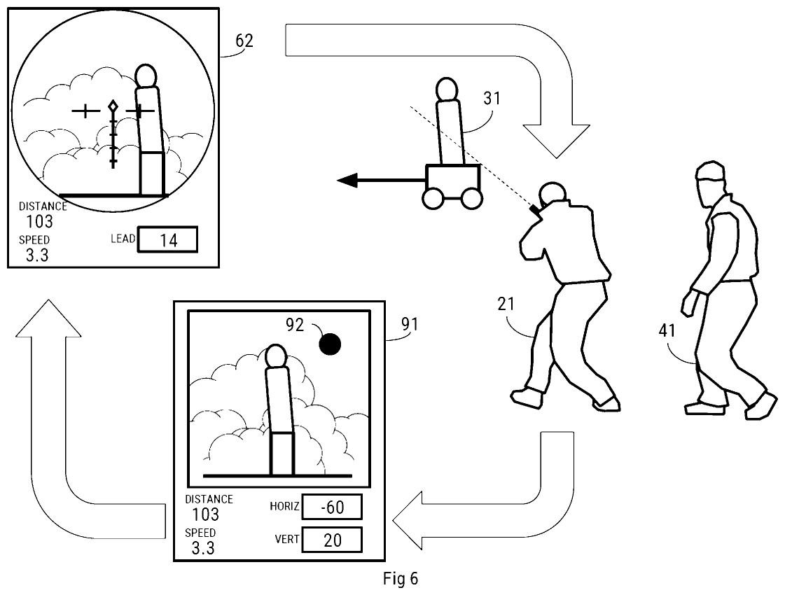

Referring to FIG. 5, the current positions of shooter 21 and target 31 are shown on the right hand side of the figure in a box labelled 61. The target 31 is moving east-to-west on the range (right-to-left in the screenshot). The shooter 21 is to the south. The line of sight to the target is represented by dotted line 71. The correct aim point with the correct lead to hit the target as calculated by the system is represented by dotted line 72.

A snapshot of the display shown on display screen 12 is shown in a box labelled 62. Display 62 visualises what the trainee shooter 21 should see through his/her scope. The target 31 is visualised by a to-scale target mannequin 64 which includes 3D and leaning effects. The background 63 (abstract ‘bushes’) moves at an appropriate speed, to give the viewer a sense of the target's speed. The ground is represented by horizontal line 66.

The correct lead is indicated numerically at number field 67. In this example the correct lead is indicated in minutes of angle (14 MOA). The actual distance to the target (103 m) and the velocity of the target (3.3 m/s) are also shown.

The trainee uses the display screen 12 as a guide to assist them in correctly aiming their own weapon at target 31. What they see in their own gun-sight should correspond with the representation 62.

The target mannequin 64 is displayed in its correct size relative to the reticle 65. The reticle 65 size is fixed (because its distance from the shooters eye does not change) but the target mannequin 64 takes up fewer pixels at longer ranges.

If the target is in fact accelerating/decelerating, the target's speed will change as the bullet is in flight, so the correct lead is slightly different. The targets 31, 32 and or control system 11 knows the planned acceleration profile of the targets, so this can also be taken into account in the calculation of the correct lead.

Referring to FIG. 5a, a scene similar to that shown in FIG. 5 is depicted but the target 31 is moving at an oblique angle 74 relative to the shooter 21. The target speed and distance are the same but the calculated lead angle is smaller, due to the oblique heading angle. It can also be seen that the representation of the target has a “3D” shape, to reflect that fact that people are wider across the shoulders than they are front-to-back. In FIG. 5 the target is side on, whereas in FIG. 5a the target is turned slightly to the side. The width of the shoulder region of the representation of the target is wider in FIG. 5a which gives the shooter a visual indication that the target orientation has changed.

Referring to FIG. 5b, a scene similar to that shown in FIG. 5 is depicted but the target 31 is now twice the distance away. The target is shown smaller and the reticle is shifted up relative to the target's centre of mass to allow for bullet drop compensation. The speed of the target remains the same but the lead angle is higher due to lower bullet speed in the 2nd half of the trajectory.

In windy conditions the shooter 21 must add an offset for wind. This could also be visualised, based on wind-speed that is either configured or measured.

The system could be used in several ways including the following:

1. Before the range practice: the instructor 41 briefs the trainees 21, 22. He or she causes a target to move down-range, and shows the class screen 12 (“OK people, look at the target moving down-range. Now look at the screen: for that target, this is the lead you should apply.”).
2. For coaching students who are not progressing: the instructor has access to screen 12, if a student is struggling then the instructor can show them the lead they should be applying.
3. As a real-time tool: each student has access to screen 12 while they're shooting. Screen 12 could take the form of a tablet computer located next to the trainee, they can shift their eyes between the target and screen 12. Alternatively, screen 12 could be in the form of a mobile phone or similar which is mounted on the weapon being used by the trainee.

The trainee shooters 21, 22 will not have access to screen 12 in combat, so they should not become reliant on it; the objective is for them to internalise it.

By placing sensors on the target 31, 32, it becomes possible to estimate the path of the bullet as it passes the target. This can be used to close the feedback loop, which one would expect should accelerate the learning cycle. The desired aim is displayed on a tablet 12 before a shot is fired on a moving target. After a shot is fired, the tablet displays whether the trainee was leading or lagging the target and by how much.

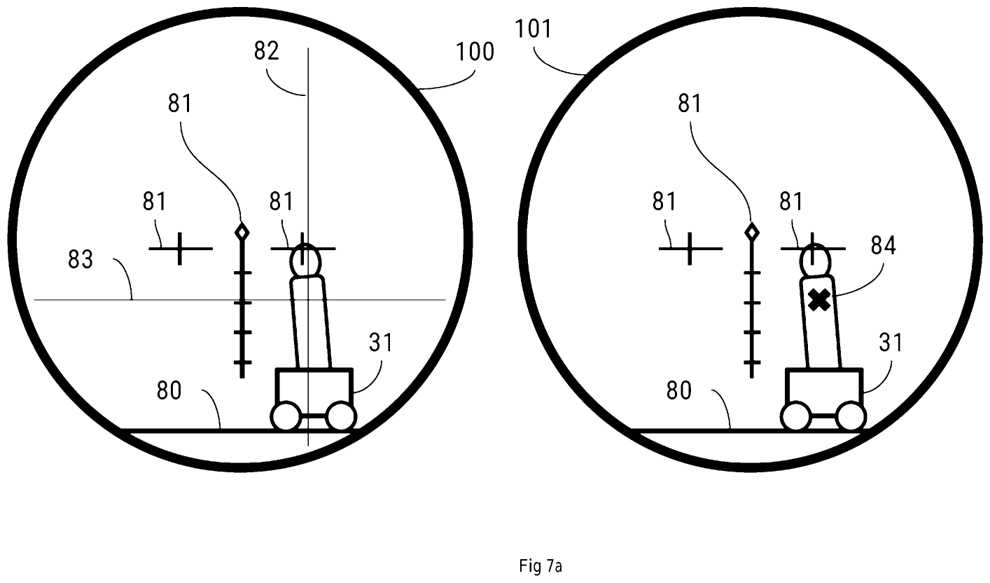

Referring now to FIG. 6, trainee 21 is under the instruction of instructor 41. The trainee takes aim at moving target 31, using the guidance provided on display screen 62. In this example, the correct desired lead is expressed as 14 MOA. The trainee fires, and misses the target. Sensors on the target detect the path of travel of the bullet to measure by how much the bullet missed the target. Feedback relating to the missed shot is displayed to the trainee on screen 12 showing interface 91. The trainee is informed that the bullet passed behind (by 60 cm) and above (by 20 cm) the intended point of impact on the target, along with a graphical representation indicating path 92 of the bullet relative to the target. The trainee will use this instant feedback to adjust his or her aim and try again.

For the bullet sensors, LOMAH (Location of Miss and Hit) sensor arrays could be used in some situations (particularly static/2D targets). Operationally, systems exist to estimate the 3D direction of incoming fire. E.g. a system called “Boomerang” uses a tetrahedral array of microphones and is designed to be mounted on vehicles. When the vehicle is shot at, the Boomerang system estimates the trajectory of the bullet and therefore the direction to the enemy shooter. A system similar to this could be mounted on the targets 31, 32.

In some cases, the weapon-mounted sight 13 can be used as a screen to display or overlay information to the trainee shooter with information overlaid over the usual weapon sight display. In FIG. 4, shooter 21 is shown using such a weapon-mounted sight 13. The sight 13 receives information (53) about the targets wirelessly from the control system computer 11.

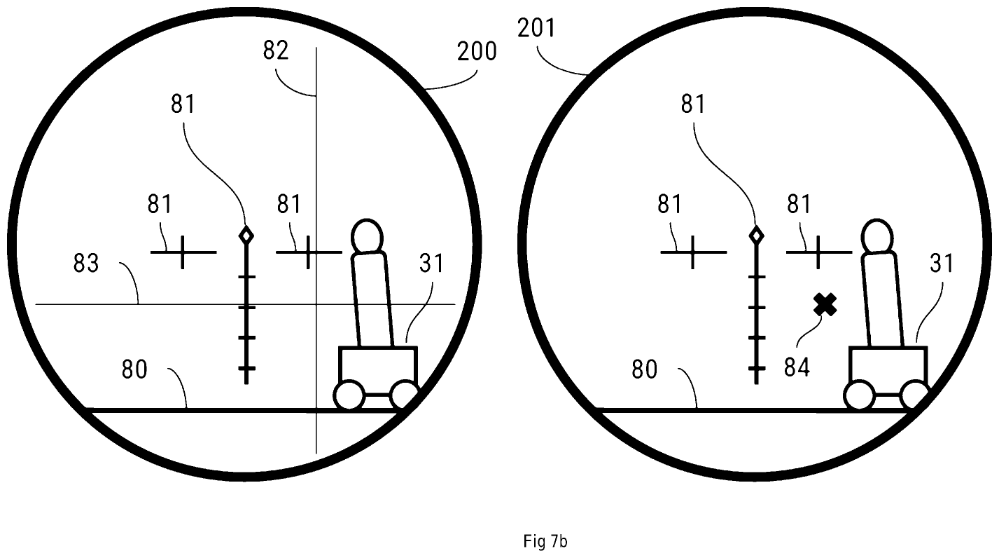

Referring to FIG. 7a, two views 100 and 101 through a weapon-mounted sight 13 with an overlay of aim coaching information. The moving target 31 is shown moving from right to left over the ground 80. The sight 13 contains a traditional static reticle 81 in one of many possible designs.

Referring to sight view 100, aim hints 82, 83 are overlaid to the sight. The correct lead is indicated by overlaid vertical line 82 while the correct BDC is indicated by overlaid horizontal line 83. The location of both aim hints 82 and 83 are continuously adjusted based on the information 53 collected by the system. To achieve correct aim, the shooter must move the weapon so that the intersection of lines 82 and 83 overlays the intended target, typically the centre of mass of moving figure.

Referring to sight view 101, the correct lead and BDC is indicated by a different style of aim hint in the form of a cross mark 84. The location of aim hint 84 is continuously adjusted based on the information 53 collected by the system. To achieve correct aim the shooter must place the mark 84 over the intended target.

In both views the shooter correctly compensates for the motion of moving target and distance from the shooter to the target.

FIG. 7b shows two views 200 and 201 through a weapon-mounted sight when the shooter does not correctly compensate for target motion and distance to the target. Referring to view 200, the intersection of lines 82 and 83 is not over the centre of mass of the intended target. Referring to view 201, the mark 84 is not over the centre of mass of the intended target. If fired from both of these configurations, the bullets will pass in front and below the intended target.

Depending on training objectives and the trainee proficiency, the instructor can disable some or all of the overlay information. For example, referring to FIG. 7b, the instructor may choose to display the correct lead line 82 but not the correct BDC line 83.

The embodiments described above utilised mobile robotic targets, but the system and methods could also be applied to rail-based targets.

In the embodiments described above, the target is visualised in very abstract form. In other embodiments it may be helpful to visualise it in a more anthropomorphic form. It could even be more human-like than the target (e.g. with moving arms/legs), because shooters are trained to use cues like arm-movement to estimate target speed.

In the embodiments utilising display in a weapon mounted sight, some or all of the lead calculations may be carried out in the sight itself, and not in the target control system.

It can be seen that embodiments of the invention provide at least one of the following advantages:
There is little motivation to study any particular cell in the prior art lead table. In contrast, there is significant motivation for knowing the correct lead for a target that the trainee is trying to hit right now.
It's difficult to transfer knowledge between the very different settings of the classroom and the range. It is not a trivial exercise to translate between the prior art lead table and the real world. If a trainee is equipped only with the lead table, and looking at a target down-range, they need to: estimate the range and the speed of the target; find the closest cells in the table; interpolate (e.g. a target at 150 m moving at a pace somewhere between a walk and a jog requires interpolation between 4 cells); compensate for target direction (e.g. reducing the lead for a target moving obliquely); and visualise the result in their head. This requires significant mental effort, and there is the possibility that one of the steps may be performed incorrectly.
Animation (showing the moving bushes, seeing the lead change as the target speed increases/decreases, and seeing the lead change as the target rotates) helps to bridge the gap between the abstract and the real-world.
Different combinations of weapon/ammunition/reticle can be handled by the system

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A method of training a person in the aiming of firearms at moving targets including the steps of:
providing at least one moving target;
calculating a correct lead for the at least one target;
displaying a visualisation of the correct lead to the person before a shot is fired;
the step of calculating the correct lead is based on any of a location of the target, a velocity of the target, an acceleration of the target, or a direction of travel of the target; and
wherein information relating to the location of the target, the velocity of the target or the direction of travel of the target is derived from an information stream transmitted by the target.

2. The method according to claim 1 wherein the steps of calculating and displaying are carried out repeatedly to provide an ongoing near real-time visualisation of the correct lead.

3. The method according to claim 1 wherein the location of the target includes an elevation of the target.

4. The method according to claim 1 wherein the information relating to the location of the target, the velocity of the target or the direction of travel of the target is derived from a target control system.

5. The method according to claim 1 wherein the step of calculating the correct lead is based on a location of the person.

6. The method according to claim 5 wherein the location of the person includes an elevation of the person.

7. The method according to claim 5 wherein the location of the person is determined from a sensor such as a GPS sensor placed on or near the person.

8. The method according to claim 5 wherein the location of the person is obtained from a previously configured control system.

9. The method according to claim 1 wherein the calculation of the correct lead is based on wind speed.

10. The method according to claim 1 wherein the visualisation includes a representation of the target.

11. The method according to claim 10 wherein the representation of the target includes a visual indication of the direction of travel of the target relative to the person's line of sight.

12. The method according to claim 10 wherein the representation of the target includes a visual indication of a distance to the target.

13. The method according to claim 12 wherein the distance to the target is indicated by a height of the representation of the target.

14. The method according to claim 1 wherein the visualisation includes a visual indication of the velocity of the target.

15. The method according to claim 14 wherein the visual indication of the velocity of the target includes a moving background image which moves to indicate the component of the velocity of the target in a direction orthogonal to the direction from the person to the target.

16. The method according to claim 14 wherein the visual indication of the velocity of the target includes visual cues in the form of arm or leg movements or leaning of the representation of the target.

17. The method according to claim 1 further including the step of providing an indication to the person of the accuracy of at least one shot which they fired.

18. The method according to claim 17 wherein the indication includes an indication of whether the shot was leading or lagging the target.

19. The method according to claim 17 wherein the indication includes an indication of by how much the shot was leading or lagging the target.

20. The method according to claim 17 wherein the indication of the accuracy shot is calculated based on the output of acoustic sensors.

21. The method according to claim 1 wherein the visual indication is displayed by overlaying it in a weapon-sight.

22. A system for training persons in the aiming of firearms including:
at least one target which is arranged to move about an area;
calculation means for calculating a correct lead for the at least one target;
display means for displaying a visualisation of the correct lead before a shot is fired;
the calculation means is arranged to calculate the correct lead based on any of a location of the target, a velocity of the target, an acceleration of the target or a direction of travel of the target; and
wherein information relating to the location of the target, the velocity of the target, the acceleration of the target or the direction of travel of the target is derived from an information stream transmitted by the target.

23. The system according to claim 22 which is arranged to repeatedly carry out the steps of calculating and displaying to provide an ongoing near real-time visualisation of the correct lead.

24. The system according to claim 22 wherein the location of the target includes an elevation of the target.

25. The system according to claim 22 wherein information relating to the location of the target, the velocity of the target, the acceleration of the target or the direction of travel of the target is derived from a target control system.

26. The system according to claim 22 which is arranged to calculate the correct lead based on a location of a person.

27. The system according to claim 26 wherein the location of the person includes an elevation of the person.

28. The system according to claim 22 wherein the calculation of the correct lead is based on wind speed.

29. The system according to claim 22 wherein the visualisation includes a representation of the target.

30. The system according to claim 29 wherein the representation of the target includes a visual indication of the direction of travel of the target relative to the person's line of sight.

31. The system according to claim 29 wherein the representation of the target includes a visual indication of a distance to the target.

32. The system according to claim 31 wherein the distance to the target is indicated by a height of the representation of the target.

33. The system according to claim 29 wherein the visualisation includes a visual indication of the velocity of the target.

34. The system according to claim 33 wherein the visual indication of the velocity of the target includes a moving background image which moves to indicate the component of the velocity of the target in a direction orthogonal to the direction from the person to the target.

35. The system according to claim 33 wherein the visual indication of the velocity of the target includes visual cues in the form of arm or leg movements or leaning of the representation of the target.

36. The system according to claim 22 which is further arranged to provide an indication to the person of the accuracy of at least one shot which they fired.

37. The system according to claim 36 wherein the indication includes an indication of whether the shot was leading or lagging the target.

38. The system according to claim 36 wherein the indication includes an indication of by how much the shot was leading or lagging the target.

39. The system according to claim 36 wherein the target includes acoustic sensors and the indication of the accuracy shot is calculated based on the output of the acoustic sensors.

40. The system according to claim 22 wherein the visual indication is displayed by overlaying it in a weapon-sight.
